(19) United States
(12) Patent Application Publication
(10) Pub. No.: US 2011/0154221 A1
(43) Pub. Date: Jun. 23, 2011

(54) SUBJECT SUGGESTION BASED ON E-MAIL RECIPIENTS

(75) Inventors: Lisa Seacat DeLuca, SAN FRANCISCO, CA (US); Meena Nigam, BELMONT, CA (US)

(73) Assignee: INTERNATIONAL BUSINESS MACHINES CORPORATION, ARMONK, NY (US)

(21) Appl. No.: 12/645,403

(22) Filed: Dec. 22, 2009

(51) Int. Cl. G06F 3/01; G06F 15/16; G06F 3/048

(52) U.S. Cl. 715/752; 715/810; 709/206

(57) ABSTRACT

Methods, apparatus and articles for dynamically inserting a subject based on an entered list of recipients. A graphical user interface (GUI) screen comprising a TO field, a carbon copy field, and a BCC field may be provided for entering a list of recipients for the e-mail, as well as a SUBJECT field for entering the subject of the e-mail. The association between the list of recipients and the subject string may then be stored, such that when the user again enters the same list of recipients into a new e-mail, the SUBJECT field may be automatically populated based on previously used subject strings.

### BACKGROUND

1. Field

Exemplary embodiments relate to electronic mail (e-mail), and particularly to assisting users to complete e-mail subject information.

2. Description of the Related Art

Electronic mail (e-mail) is a widespread form of communication between users of computerized devices. Typically, e-mails are composed and sent using an e-mail client application. The e-mail client generates a graphical user interface (GUI) that may allow a user to enter a message. The GUI may also include one or more fields, for example, a TO field, a CC (carbon copy) field, a BCC (blind carbon copy) field, or the like, for entering a list of recipients of the e-mail, as well as a SUBJECT field for entering a subject of the message.

### SUMMARY

In accordance with exemplary embodiments, methods, systems and articles for dynamically inserting a subject based on an entered list of recipients are provided. In one embodiment, a list of recipients inputted by a user for an e-mail is received. The list of recipients is parsed to automatically identify one or more subjects associated with the list of recipients, the identified one or more subjects being made available for insertion into a SUBJECT field of the email based on the list of recipients entered by the user. The selected subject of the one or more suggested subjects is then inserted into the SUBJECT field of the e-mail.

For example, an e-mail management process may parse the email and determine whether a previously stored association(s) exists between the list of recipients and one or more corresponding subjects. The association(s) may have been created by the user during composition of a previous e-mail with the same list of recipients. In response to recognizing that such an association exists, the one or more previously-stored corresponding subjects that relate to the list of recipients are made available to the user. For example, the one or more corresponding subjects may be respectively inserted into a SUBJECT field of the e-mail. In the event that the list of recipients is associated with more than one corresponding subject, the user may be given the option to select one of the corresponding subjects (e.g., from a drop-down menu). In this way, composition of e-mails is facilitated by automatically identifying possible subject lines based on the list of recipients entered by the user.

Additional features and advantages are realized through the techniques of the exemplary embodiments. Exemplary embodiments of the invention are described in detail herein and are considered a part of the claimed invention. For a better understanding of features, refer to the description and to the drawings.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 illustrates an exemplary computer system according to an embodiment of the invention.

FIG. 2 illustrates an exemplary system for exchanging e-mails according to an embodiment of the invention.

FIG. 3 illustrates automatically completing subject information in an e-mail according to an embodiment of the invention.

FIG. 4 illustrates an exemplary graphical user interface for composing an e-mail, according to an embodiment of the invention.

FIG. 5 illustrates an exemplary graphical user interface for composing an e-mail, according to an embodiment of the invention.

FIG. 6 illustrates an exemplary graphical user interface for presenting multiple subject string suggestions, according to an embodiment of the invention.

FIG. 7 illustrates an exemplary graphical user interface for presenting a partial subject string suggestion, according to an embodiment of the invention.

### DETAILED DESCRIPTION OF THE PREFERRED EMBODIMENTS

Embodiments of the invention provide methods for automatically identifying possible e-mail subject information based on an entered list of recipients. An e-mail client application may include a graphical user interface (GUI) screen comprising a TO field, a carbon copy (CC) field, and at least one blind carbon copy (BCC) field may be provided for entering a list of recipients for the e-mail. The e-mail client application may then provide the user (e.g., by auto-populating or by a drop-down menu) identified subject string suggestions and display possible entries for the SUBJECT field based on the list of recipients entered in the TO, CC and/or BCC fields.

In the following, reference is made to embodiments of the invention. However, it should be understood that the invention is not limited to the specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Additionally, computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

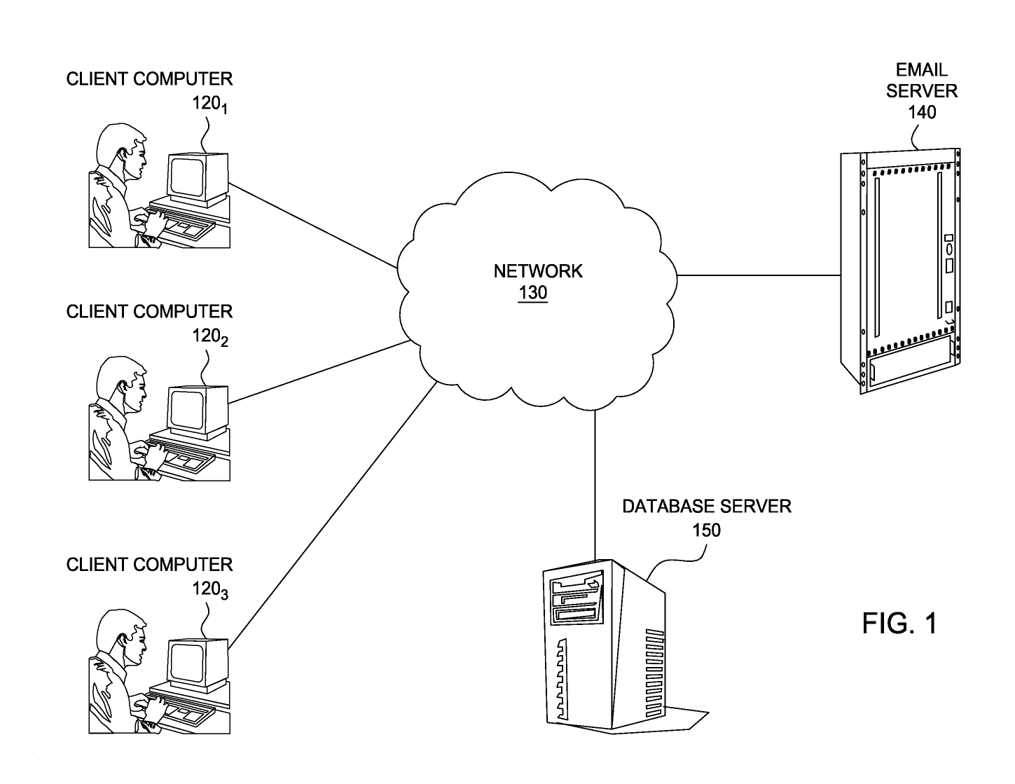

Exemplary embodiments provide a mechanism to dynamically populate an e-mail SUBJECT field based on an entered list of recipients of an e-mail. FIG. 1 illustrates one or more client computers 120₁ . . . 120_{N} (which are part of a networked computer system 100) that become special-purpose computers according to an embodiment of the invention when configured with the features and functionality described herein. The client computer systems 120₁ . . . 120_{N} may represent any type of computer, computer system or other programmable electronic device, including a client computer, a server computer, a portable computer, a personal digital assistant (PDA), a cell phone, an embedded controller, a PC-based server, a minicomputer, a midrange computer, a mainframe computer, and other computers adapted to support the methods, apparatus, and article of manufacture of the invention. The terms client computer and server computer are used herein merely for convenience in describing embodiments and in general may refer to any computer, including a computer containing both client-type software and server-type software.

Illustratively, the client computers 120₁ . . . 120_{N} are part of a networked system 100. In this regard, the invention may be practiced in a distributed computing environment in which tasks are performed by remote processing devices that are linked through a communications network. In a distributed computing environment, program modules may be located in both local and remote memory storage devices. In another embodiment, the client computers 120₁ . . . 120_{N} are a standalone device. For purposes of construing the claims, the term “computer” shall mean any computerized device having at least one processor. The computer may be a standalone device or part of a network in which case the computer may be coupled by communication means (e.g., a local area network or a wide area network) to another device (i.e., another computer).

In any case, it is understood that FIG. 1 is merely one configuration for a computer system. Embodiments of the invention can apply to any comparable configuration, regardless of whether the client computers 120₁ . . . 120_{N} are a complicated multi-user apparatus, a single-user workstation, or a network appliance that does not have non-volatile storage of its own.

The client computers 120₁ . . . 120_{N} may connect to a network 130 via a network interface. The network interface may enable connection to the network 130 via a wired or a wireless connection. The network 130 is representative of any network, including, for example, a corporate/office/enterprise intranet, university intranet, or home/personal intranet. The network 130 may also be a large wide-area network (WAN) such as the Internet.

The client computers 120₁ . . . 120_{N} may also connect to a database server 150 via the network 130. The database server 150 may allow e-mail clients running on the client computers 120₁ . . . 120_{N} to store and retrieve information used for particular embodiments of the present invention. It is contemplated that there may be more than one database running on one or more database servers 150 and that, in embodiments where the computer system 100 includes multiple databases, different databases may be used for different purposes. Furthermore, it is contemplated that the database(s) may run on one or more of the client computers 120₁ . . . 120_{N}, and/or on the e-mail server computer 140. Thus, the embodiment shown in FIG. 1 with the standalone database server 150 as a standalone computer is for illustrative purposes only.

The networked system 100 also may include an e-mail server computer 140. It is contemplated that the e-mail server computer 140 may also be a plurality of computers, and the example of a single server computer is for illustrative purposes only. Generally, in terms of hardware architecture, the server computer 140 may include one or more processors, memory, and one or more data storage devices that are communicatively coupled via a local interface. Additionally, the server computer may connect to the client computers 120₁ . . . 120_{N} via the network 130 for purposes of facilitating the sending and receiving e-mail messages. Generally, an e-mail client running on the client computers 120₁ . . . 120_{N} may connect to an e-mail server program running on the e-mail server computer 140 in order to send and receive e-mail messages.

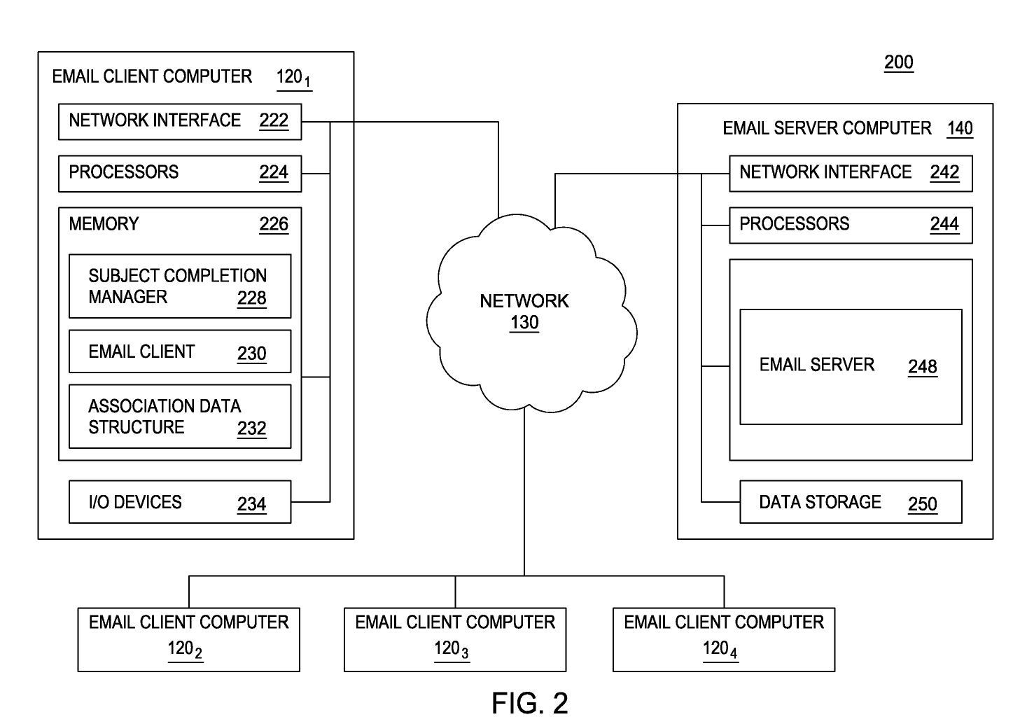

FIG. 2 illustrates an exemplary computer system 200 in which portions of e-mail messages may be automatically completed according to embodiments of the present invention. The networked environment 200 may comprise a network 260, a remote mail server 240 and a plurality of client computers 220₁ . . . 220_{N}. The client computers 220₁ . . . 220_{N} may each contain one or more computer processors 224, memory 226, and one or more I/O devices 234. The client computers 220₁ . . . 220_{N} may contain in memory 226 a Subject Completion Manager (SCM) 228 and an e-mail client 230. The SCM 228 is a computer program that interacts with the e-mail client 230 and/or the e-mail server 248 to automatically populate e-mail subject information based on an entered list of recipients.

Generally, in terms of hardware architecture, the client computers 220₁ . . . 220_{N} may include one or more processors 224, memory 226, and one or more input and/or output (I/O) devices 234 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 224 is a hardware device for executing software that can be stored in the memory 226. The processor 224 can be virtually any custom made or commercially available processor, a central processing unit (CPU), a data signal processor (DSP), or an auxiliary processor among several processors associated with the computer 220, and the processor 224 may be a semiconductor based microprocessor (in the form of a microchip) or a macroprocessor.

The main memory 226 is any memory sufficiently large to hold the necessary programs and data structures. The memory 226 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 226 may incorporate electronic, magnetic, optical, and/or other types of storage media. In addition, memory 226 may be considered to include memory physically located elsewhere in a computer system 200, for example, any storage capacity used as virtual memory or stored on a mass storage device (e.g., direct access storage device) or on another computer coupled to the client computer 220₁ . . . 220_{N} via a bus. Thus, main memory 226 and one or more storage devices (not pictured) could be part of one virtual address space spanning multiple primary and secondary storage devices.

The I/O devices 234 may include input devices such as, for example but not limited to, a mouse, keyboard, scanner, microphone, camera, etc. Furthermore, the I/O devices 128 may also include output devices, for example but not limited to a printer, display, etc. Further, the I/O devices 234 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 234 also include components for communicating over various networks, such as the Internet or intranet.

The memory 226 may include one or more separate programs, each of which comprises an ordered listing of executable instructions for implementing logical functions. The software in the memory 226 may include an operating system (O/S) and one or more applications in accordance with exemplary embodiments. An operating system contained in memory may control the execution of other computer programs, and provides scheduling, input-output control, file and data management, memory management, and communication control and related services. It is contemplated by the inventors that the application for implementing exemplary embodiments may be applicable on all commercially available operating systems. Examples of operating systems include UNIX, versions of the Microsoft Windows® operating system, and distributions of the Linux® operating system. (Note: Linux is a trademark of Linus Torvalds in the United States and other countries.) More generally, any operating system supporting the functions disclosed herein may be used.

The SCM application 228 in memory 226 may comprise numerous functional components for implementing the features and operations of the exemplary embodiments. The applications in memory 226 may represent various applications, computational units, logic, functional units, processes, operations, virtual entities, and/or modules in accordance with exemplary embodiments, but the SCM 228 is not meant to be a limitation. The SCM 228 may be a source program, executable program (object code), script, or any other entity comprising a set of instructions to be performed. When a source program, then the program is usually translated via a compiler, assembler, interpreter, or the like, which may or may not be included within the memory 226, so as to operate properly in connection with the O/S. Furthermore, the application may be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

When the SCM 228 is implemented in software it should be noted that the SCM 228 can be stored on virtually any computer readable medium for use by or in connection with any computer related system or method. That is, the SCM 228 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. As discussed above, in the context of this document, a computer readable medium may be an electronic, magnetic, optical, or other physical device or means that can contain or store a computer program for use by or in connection with a computer related system or method.

Alternatively, in exemplary embodiments, the SCM 228 may be implemented in hardware. In such an embodiment, the SCM 228 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Note that in some embodiments, the SCM 228 may be running on a single client computer 220₁ . . . 220_{N}, all or part of the client computers 220₁ . . . 220_{N}, on the e-mail server computer 240 or on a different computer or device altogether. As an example, in an environment where the client computers 220₁ . . . 220_{N} each run a standalone e-mail client 230, the SCM 228 may reside in memory on each client computer 220₁ . . . 220_{N} and interact with the standalone e-mail client 230 to facilitate automatic e-mail subject completion. Alternatively, in an environment where the e-mail server 248 provides a webmail service (and thus the e-mail client 230 consists of a web browser displaying web pages retrieved from the e-mail server 248), the SCM 228 may reside on the e-mail server computer 240 and interact with the e-mail server program 248 to facilitate automatic e-mail subject completion. Thus, it is contemplated that the SCM 228 may reside on any number of different computers, or may be a standalone hardware device, and the illustration in FIG. 2 of the SCM 228 residing on each client computer is for illustrative purposes only.

The network 260 may be any network, including, for example, a corporate/office/enterprise intranet, university intranet, or home/personal intranet. Network 260 may also be a large wide-area network (WAN) such as the Internet. The client computers 220₁ . . . 220_{N} may connect to the server computer 240 through the network 260. Additionally, the network 260 may include circuit-switched and/or packet-switched technologies and devices, such as routers, switches, hubs, gateways, etc., for facilitating communications. The network 260 may include wireline and/or wireless components utilizing, e.g., IEEE 802.11 standards for providing over-the-air transmissions of communications. The network 260 can include IP-based networks for communication between a customer service center and clients/users. In short, the network 260 is representative of any number of network configurations and is not intended to be limited to any given network configuration.

The client computers 220₁ . . . 220_{N} can operatively connect to one or more e-mail servers 240 via the network 260. The e-mail server 240 is a computing device and may include, without limitation, any of the features discussed herein for the server computer 140. The client computers 220₁ . . . 220_{N} may include an e-mail client application 230 and, likewise, the e-mail server 240 may include an e-mail server application 248. The e-mail client application 230 and the e-mail server application 248 interact to provide e-mail services for a user of the e-mail client computers 220₁ . . . 220_{N}, as understood by one skilled in the art. The e-mail server 240 and the e-mail client computers 220₁ . . . 220ₖ can operatively communicate with other e-mail servers and computers to transmit and receive e-mails. Further, the e-mail server 240 and the e-mail client computer 220₁ . . . 220_{N} may include or be operatively connected to databases or other data stores for storing information as discussed herein according to exemplary embodiments.

The e-mail server 248 included on the e-mail server computer 240 may provide a variety of e-mail services to each of the client computers 220₁ . . . 220_{N}. These e-mail services may be provided on a variety of different scales. For instance, the provided e-mail services may include large Internet services such as Yahoo! Mail™ or Hotmail™. The e-mail services may also include mid-size and smaller e-mail services, such as enterprise level, corporate or business e-mail services, university e-mail services, and home or personally run e-mail services. In some cases, the e-mail server 248 may provide e-mail services in one or more protocols. The provided e-mail protocols may include the Post Office Protocol (POP, including, for instance, versions POP2 or POP3), the Simple Mail Transfer Protocol (SMTP), and Internet Message Access Protocol (IMAP), as well as any other appropriate protocol.

According to one embodiment of the invention, each e-mail server computer 240 may have e-mail server software 248 which implements each provided protocol and provides e-mail services to each of the clients. In one embodiment, each client computer 220₁ . . . 220_{N} may access the e-mail services provided by the e-mail server software 248 using an e-mail client program 230. When the e-mail server software 248 receives an access request (e.g., a request to check, read, or send e-mail) from the e-mail program 230, the e-mail server software 248 may access an e-mail data store 250 and use information within the e-mail data store 250 to process the request. The e-mail data store 250 may include any information, including sent e-mail messages, sent e-mail attachments, drafted messages, received e-mail messages, received e-mail attachments, user information, and any other information used by the e-mail server software 230. In some cases, each client computer 220₁ . . . 220_{N} may also store e-mail information which may include e-mail messages, e-mail attachments and/or cached copies of e-mail information stored in a remote e-mail data store.

Client computers 220₁ . . . 220_{N} depicted in FIG. 2 may access the e-mail services provided by the server computer 240 using a variety of access methods and configurations. Where client computers 220₁ . . . 220_{N} are located within an intranet (i.e. when network 260 consists of an intranet connection), the client computers 220₁ . . . 220_{N} may connect directly to the server computer 240 within the network 260 with an e-mail program 230 configured to access the server computer 240. The e-mail client program 230 may use one or more of the protocols described above to access the e-mail server software 234.

Where client computers 220₁ . . . 220_{N} outside of an intranet access the server computer 240 inside the intranet, the external client computers 220₁ . . . 220_{N} may use a virtual private network (VPN) to create a connection. The VPN may be accessed by the client computers 220₁ . . . 220_{N} using a VPN client (not shown). Thus, in some cases, the VPN client may be used in conjunction with the e-mail program 230 to access the e-mail services provided by the e-mail server software 248 on the server computer 240.

The e-mail server 248 may also provide e-mail services using a web based e-mail service (also referred to as a webmail service, or Internet mail service). The web based e-mail service may be implemented using web server software on the server computer 240 which provides each client computer 220₁ . . . 220_{N} a series of web pages. According to one embodiment of the invention, each client computer 220₁ . . . 220_{N} may use web browser software or the e-mail program 230 to access the web based e-mail service. Each client computer 220₁ . . . 220_{N} may access the web based e-mail services provided by the server computer 240 using a variety of protocols, including the Hypertext Transfer Protocol (HTTP), File Transfer Protocol (FTP), Telnet, etc.

The web pages provided by web server software on the e-mail server computer 240 may be used to access e-mail services provided by the server computer 240. Accordingly, the web pages may utilize one or more forms, such as Hypertext Markup Language (HTML) forms, and/or one or more scripts and/or applets to process requests from client computers 220₁ . . . 220_{N}. The scripts used to access the e-mail services may include scripts executed by the server computer 240. Scripts executed by the server computer 240 (referred to as server-side scripts) may be executed, for example, by web server software, e-mail server software 248, or other server software. The scripts used to access the e-mail services may also include scripts executed by the client computers 220₁ . . . 220_{N} (referred to as client-side scripts) and may be executed, for example, by the e-mail client program 230, a web browser, or other client software.

Networked environment 200 is merely an exemplary networked environment and other configurations, variations, and components of the networked environment (such as routers, storage servers, file servers, etc. . . . , not depicted) should be readily apparent to one of ordinary skill in the art. For instance, in some embodiments, multiple separate computers may be used as web and e-mail servers, with one or more computers executing for the web server software and one or more computers executing e-mail server software 248. In some cases, each e-mail service may provide several e-mail domains wherein a separate e-mail server provides e-mail service to each domain and wherein an e-mail router is used to route all e-mail received by the e-mail service to the appropriate e-mail server. In general, embodiments of the invention may be adapted for use in any situation in which electronic messages are transmitted.

Embodiments of the invention are not limited to the client-server model described hereinabove. Advantages of the invention may also be realized in alternative arrangements and networks of computer systems such as, for example, peer-to-peer (P2P) networks. Furthermore, embodiments of the invention are described herein with reference to e-mail messages for illustrative purposes only. In alternative embodiments, advantages of the invention may be realized with respect to any type of electronic message including, for example, text messages, instant messages, or the like.

Furthermore, exemplary embodiments are not limited to but are capable of being implemented in the system 200 illustrated in FIG. 2. Additionally, the server 240 may be representative of numerous servers. The client computers 220₁ . . . 220ₖ may be representative of numerous computing devices. Therefore, the system 200 illustrated in FIG. 2 is neither limited numerically to the elements depicted therein nor limited to the exact configuration and operative connections of elements. Further, it is understood by those skilled in the art that elements may be added to, subtracted from, or substituted for the elements described in FIG. 2.

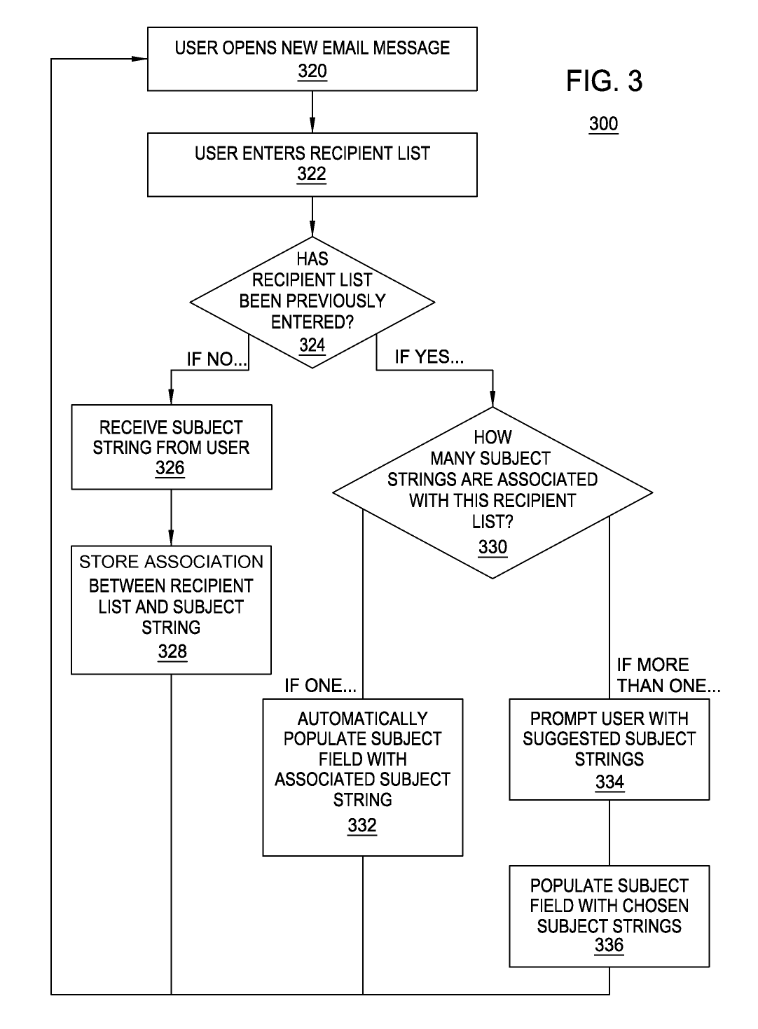

FIG. 3 illustrates automatically completing subject information in an e-mail according to an embodiment of the invention. Beginning at step 320, a user opens or creates a new e-mail message. This may be accomplished via an e-mail client, such as e-mail client 230, which may be a standalone e-mail client, a web e-mail client, or any other form of e-mail client. That is, step 320 represents a user opening a new e-mail message on any e-mail client capable of sending e-mail messages and configured to interact with the SCM 228 (which may be integrated with the e-mail client).

The new e-mail message may generally contain, at a minimum, a SUBJECT field, a TO field, and a body of the message. The new e-mail message will also typically include CC and BCC fields. Once a new e-mail message has been opened, a user may then input one or more recipients into the TO, CC, and BCC fields of the e-mail (as a user would normally do to send a new e-mail message) (at step 322). As used herein, a “list of recipients” is intended to mean one or more recipients, and consists of one or more recipients to which the new e-mail message will be sent, entered into TO, CC, BCC, and any other equivalent fields in an e-mail message.

Once the user has entered the list of recipients into the e-mail, the SCM 228 may determine whether the user has entered that particular list of recipients previously. In one embodiment, making this determination is done by accessing the association data structure 232 to determine whether the list of recipients is contained in the data structure. It is contemplated that, in some embodiments, the SCM 228 need not identify an exact match between the list of recipients just entered and the respective lists contained in the data structure. Rather, the SCM 228 may be configured to identify subsets or supersets of the entered list. However, for purposes of this description, it will be assumed that SCM 228 evaluates the list for an exact match. If the SCM 228 determines that the list of recipients has not been previously entered (at step 324), then the SCM 228 allows the user to enter the subject string into the SUBJECT field of the e-mail (at step 326). It is contemplated that the user may enter the recipients and/or the subject string by the use of a keyboard, touch pad, voice transcription or by other means known in the art.

Once the user enters the subject string, the SCM 228 may store this subject string and the associated list of recipients (at step 328). By storing the recipient list and the associated subject string entered by the user (at step 328), the SCM 228 may later use this information to automatically populate the SUBJECT field when the user enters the same list of recipients into a new e-mail. The SCM 228 may store this information in the association data structure 232, in a database or in other data storage means. The SCM 228 may store this information on the e-mail client computer 220, the e-mail server computer 240, or on another storage device (such as the association database server 150).

If at step 324 the SCM 228 determines that the user has entered the recipient list before, then the SCM 228 may determine how many subject strings are associated with the entered recipient list (at step 330). If only a single subject string has been stored for the entered recipient list, the SCM 228 may automatically populate the SUBJECT field of the e-mail with the associated subject string (332). Alternatively, if the SCM 228 determines that more than one subject string is associated with the entered list of recipients, the SCM 228 may prompt the user with two or more suggested subject strings (at step 334), from which the user can then select.

For example, a user may type the subject “Weekly Status Meeting” when sending an e-mail to “Sue@e-mail.com” (Sue) and “Joe@e-mail.com” (Joe). In accordance with exemplary embodiments, the SCM 228 may be configured to recognize that every time the list of recipients consisting of Sue and Joe is typed by the user, then the user is sending an e-mail with subject “Weekly Status Meeting.” This information may be stored by the e-mail client application 240 and/or the e-mail server application 250. Thus, the next time the user opens a new e-mail and enters recipients Sue and Joe, the SCM 228 may automatically populate the SUBJECT field of the e-mail with the subject string “Weekly Status Meeting.”

Alternatively, if the SCM 228 determines that more than one subject association with the recipient list exists (at step 330), the SCM 228 may prompt the user with a list of two or more suggested subject strings and allow the user to choose which subject string to use for the e-mail (at step 334). For instance, if the user has previously sent e-mails to Sue and Joe with the subjects “Monday Meeting” and “Tuesday Meeting”, when the user opens a new e-mail and enters Sue and Joe as the recipients, the SCM 228 may prompt the user with a drop-down list containing the subject suggestions “Monday Meeting” and “Tuesday Meeting.” In such a scenario, once the user selects a subject suggestion from the drop-down list, the SCM 228 may populate the SUBJECT field of the e-mail with the selected subject (at step 336).

It is contemplated that the SCM 228 may use user interfaces other than a drop-down list to display the subject suggestions. Additionally, the SCM 228 may use different methods of displaying the subject suggestions (at step 334) in order to highlight the most relevant suggestions to the user. For instance, the SCM 228 may order the subject suggestions by listing the most recently used subjects first (chronological listing). Alternatively, the SCM 228 may order the subject suggestions by listing the most often used subjects first (frequency-based listing). In short, it is contemplated that the SCM 228 may use a variety of different user interfaces and ordering methods to display the subject suggestions. Additionally, it is understood by those of skill in the art that the manner of displaying the potential subject strings is not determinative for the present disclosure, and any number of user interface techniques (in addition to the aforementioned drop-down list) may be used to display these strings.

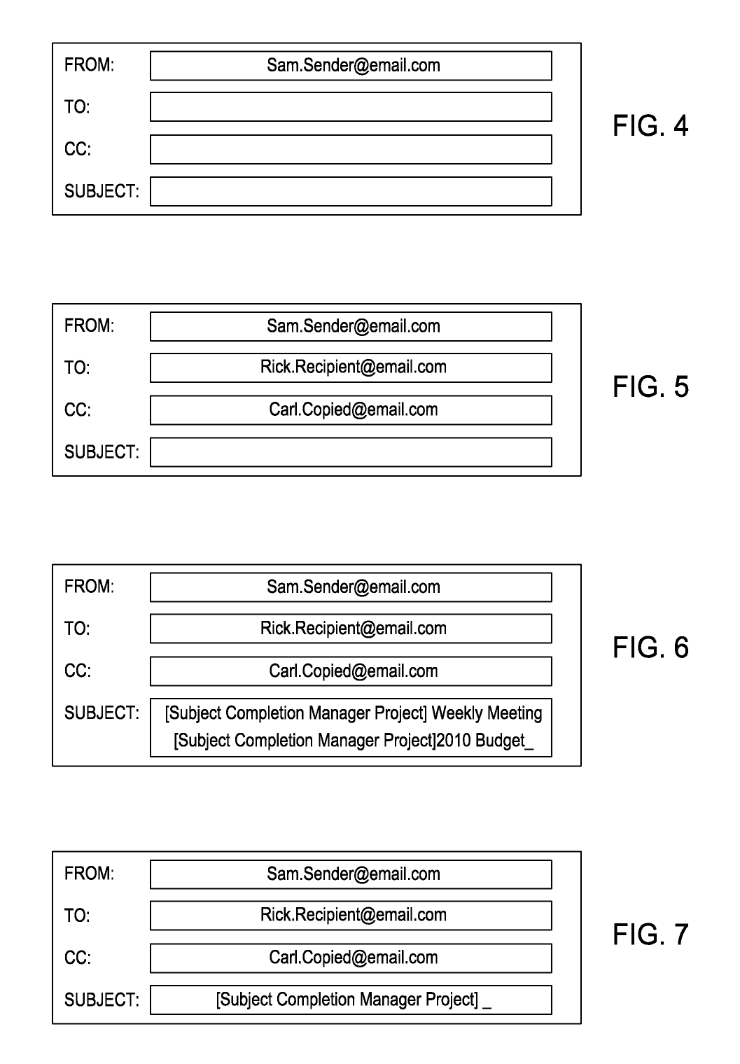

FIGS. 4-7 illustrates an exemplary graphical user interface for composing an e-mail, according to an embodiment of the invention. FIG. 4 shows an exemplary blank e-mail header, such as would be seen by a user upon opening a new e-mail message (as in step 320). The user may then enter one or more recipients into the TO and CC fields of the newly opened e-mail (step 322). For example, if the user wishes to send an e-mail to “Rick.Recipient@e-mail.com” and “Carl.Copied@e-mail.com”, the user may enter this information into the e-mail as shown in FIG. 5. Continuing this example, if the SCM 228 recognizes that the user has previously used two different subjects in sending e-mails to these recipients, for example the subjects “[Subject Completion Manager Project] Weekly Meeting” and [Subject Completion Manager Project] 2010 Budget”, the SCM 228 may prompt the user with these choices, as shown in FIG. 6. If the user selects one of the suggested subjects, the SCM 228 may then populate the SUBJECT field with the selected subject string.

It is contemplated that the SCM 228 may automatically populate the SUBJECT field in real-time as the user is entering a list of recipients. Under such a configuration, the subject string may potentially change or the user may be prompted with suggested subject strings after each e-mail recipient has been entered by the user. In an alternative environment, the SCM 228 may wait until the user finishes entering the list of recipients before the SCM 228 automatically populates the SUBJECT field or prompts the user with suggested subject strings. For instance, in such a configuration, the SCM 228 may populate the SUBJECT field only after the user brings his cursor into the SUBJECT field of the e-mail. In a similar configuration, the SCM 228 may populate the SUBJECT field once the user brings his cursor into any field other than a recipient field (i.e. TO, CC, BCC, etc.). Thus, under this example, if the user enters the recipients “Rick.Recipient@e-mail.com” and “Carl.Copied@e-mail.com” into the TO and CC fields, respectively (as shown in FIG. 5), the SCM 228 may not prompt the user with the suggested subject strings (as shown in FIG. 6) until the user brings the cursor into the SUBJECT field or into the body of the message (not shown).

In an alternate embodiment, the SCM 228 may automatically complete only a portion of the subject string, as opposed to automatically populating the entire subject string. That is, in an environment where the user has sent numerous e-mails to the same list of recipients, wherein all or a portion of the e-mails share a common substring, the SCM 228 may be configured to automatically populate the SUBJECT field of new e-mails with the common substring. For example, continuing the example shown in FIG. 6 where the user has previously sent e-mails to Rick and Carl with subjects sharing the common prefix “[Subject Completion Manager Project]”, the SCM 228 may be configured to automatically populate the SUBJECT field of new e-mails to Rick and Carl with the common prefix of “[Subject Completion Manager Project]”, as is shown in FIG. 7. The user can then complete the subject line as they see fit. It is also contemplated that the SCM 228 may be configured to automatically populate the subject field with a common suffix used in previous e-mails. Alternatively, the SCM 228 may be configured to recognize more complex patterns in previously used subject strings, wherein the SCM 228 may populate the static portions of the pattern and prompt the user to input the dynamic potions of the string. In this context, static portions refer to those portions of a subject line that are repeated in different e-mails to the same recipients, while the dynamic portion refers to those portions of the subject lines that vary. In the example above, the prefix [Subject Completion Manager Project] is identified as the static portion (i.e., that portion of a subject line that is repeated in multiple e-mails to the same recipients), while any characters that followed that portion varied between the multiple e-mails and, therefore, define the dynamic potion. As a more complex example, consider a docket number having the following format: [geographic code]_[type_ID]_[year]_[matter_number]_[extension]. A specific docket number may read SVL_{—}9_{—}2009_{—}0026_US1. In a typical e-mail exchange between a sender and recipient list, the portion of this docket number that changes most frequently may be the matter_number (i.e., “0026” in the foregoing example). Accordingly, the matter number is considered to be the dynamic portion and the remainder of the docket number is considered to be the static portion. Hence, the SCM 228 may associate a template subject line with the recipient list: SVL_{—}9_{—}2009_????_US1. The “????” represent parameter markers to be specified by the user after the template subject line is inserted into the SUBJECT field.

In another embodiment, the SCM 228 may also be configured to automatically complete the subject field by the use of a preconfigured template or rule. In such a configuration, the SCM 228 may automatically populate the SUBJECT field of new e-mail messages by applying one or more rules or templates to previously stored subject strings. As an example, assume a user sent an e-mail on Oct. 10, 2009 to recipients Rick and Carl with the subject “Meeting Notes—Oct. 10, 2009.” In one embodiment of the invention, the SCM 228 may be configured to recognize the pattern of a “Meeting Notes”—prefix followed by the current date. Under such a configuration, if on Oct. 20, 2009, the user again sends an e-mail to Rick and Carl, the SCM 228 may be configured to automatically populate the SUBJECT field based on this pattern with the prefix followed by the current date, suggesting the subject string “Meeting Notes—Oct. 20, 2009.”

As a second example, the SCM 228 may be configured to automatically convert all or part of the SUBJECT field to a corresponding alias when the user sends an e-mail to a particular list of recipients. To illustrate this, the SCM 228 may determine that e-mails received from sender Sam often contain an internal reference number in the subject line. Following this example, the SCM 228 may further determine that emails the user sends to recipient Rick often contain an external reference number in the subject line. In some cases, the user may want to forward an e-mail from Sam (whose subjects often contain internal reference numbers) to Rick (whose subjects often contain external reference numbers). Upon detecting this event, the SCM 228 may then use a preconfigured rule or template to suggest a new subject line that replaces the internal reference number with the equivalent external reference number. For example, the SCM 228 may determine whether an alias exists for the internal reference number contained in the SUBJECT field of the e-mail received from Sam by accessing an alias data structure (which may reside locally or remotely, such as in a database on the database server 150) that relates the internal reference number to one or more aliases, such as the external reference number. If a matching alias found the internal reference number in the SUBJECT field is replaced with the matching alias (in this case the external reference number). In the event that multiple matching aliases are identified, the user may be presented with a drop-down menu containing the matching aliases. The SCM 228 populates the SUBJECT field with the user selection from the drop-down menu.

Alternatively, or additionally, to referencing information contained in the subject string of the email being forwarded, the SCM 228 may parse the body of emails to identify possible subject string suggestions based on pre-existing associations between the selected recipients and previously-used subject strings. It is contemplated that in this example the SCM 228 may use a pattern-matching algorithm to make such a conversion. Additionally, the SCM 228 may use an external data store (such as a database on the database server 150) to look up one or more replacement values. The data store may also be located on one or more e-mail client computers 220₁ . . . 220_{N}, on an e-mail server computer 240, and/or on a separate resource altogether. Additionally, these examples are intended as a nonexhaustive list of contemplated embodiments, and are not intended as a limitation.

It is also contemplated that the SCM 228 may use the association between a list of recipients and previously used subject strings to automatically populate other portions of the e-mail message. In particular, it will be appreciated that each of the foregoing embodiments for dynamically selecting a subject based on a specified recipient list may equally be applied to dynamically selecting a recipient list based on a specified subject. That is, the SCM 228 may use the association information to populate a list of recipients based on an entered subject string. As an example, assume a user has previously sent an e-mail message to “Rick.Recipient@e-mail.com” with the subject “Lunch Today?” If the user later opens a new e-mail message and enters “Lunch Today?” into the subject string of that e-mail, the SCM 228 may automatically populate the TO field of the e-mail with “Rick.Recipient@e-mail.com.” Thus, in this example, the SCM 228 may populate the recipient fields (TO, CC, BCC), rather than populating the subject string, by use of the association between previously used subjects and their respective lists of recipients.

In another embodiment, the SCM 228 may maintain associations between previously used subject strings and respective lists of recipients for an entire group of users. That is, the SCM 228 may maintain subject/recipient associations for e-mails sent by any user of the group, and may reference this information whenever any user goes to send a new e-mail. For example, assume Sam and Fred are both users in a particular group, and Sam has previously sent an e-mail to “Rita@e-mail.com” with the subject string “Weekly Status Meeting”. If Fred then opens a new e-mail and enters “Rita@e-mail.com” into the TO field, the SCM 228 may automatically populate the SUBJECT field of the e-mail with the string “Weekly Status Meeting” based on the subject/recipient association from Sam's previous e-mail. It is also contemplated that e-mails under such a configuration may be marked “private” before they are sent, at which point the SCM 228 would not store the association between the list of recipients and the subject string.

While the foregoing is directed to embodiments of the present invention, other and further embodiments of the invention may be devised without departing from the basic scope thereof, and the scope thereof is determined by the claims that follow.

What is claimed is:

1. A method of dynamically inserting a subject based on an entered list of recipients comprising:
receiving a list of recipients input by a user for an e-mail;
parsing the list of recipients to automatically identify one or more subjects associated with the list of recipients, the identified one or more subjects being made available for insertion into a SUBJECT field of the email based on the list of recipients entered by the user; and
inserting one of the one or more subjects into the SUBJECT field of the e-mail.

2. The method of claim 1, wherein parsing the list of recipients to automatically identify one or more subjects associated with the list of recipients comprises accessing a data structure containing associations between a plurality of lists of recipients and corresponding subjects, the associations having been generated from previous emails composed by the user.

3. The method of claim 1, wherein parsing the list of recipients to automatically identify one or more subjects associated with the list of recipients comprises:
determining that the e-mail SUBJECT field already contains an existing subject; and
identifying an alias for the existing subject based on the list of recipients.

4. The method of claim 1, wherein inserting one of the one or more subjects into the SUBJECT field of the email comprises auto populating the SUBJECT field.

5. The method of claim 1, wherein parsing the list of recipients to automatically identify one or more subjects associated with the list of recipients comprises accessing a data structure containing associations between a plurality of lists of recipients and corresponding subjects, the associations having been generated from previous e-mails composed by the user.

6. The method of claim 1, wherein inserting one of the one or more subjects comprises:
prompting the user with a subject list of the identified one or more subjects; and
receiving a user selection of a subject from the subject list.

7. The method of claim 6, wherein the subject list is arranged according to one of:
a chronological order based on when each of the one or more subjects was last used in another e-mail by the user; and
a frequency-based order according to the frequency with which the one or more subjects have been used in other emails by the user.

8. A computer readable storage medium containing a program which, when executed, performs an operation for dynamically inserting a subject based on an entered list of recipients, comprising:
receiving a list of recipients input by a user for an e-mail;
parsing the list of recipients to automatically identify one or more subjects associated with the list of recipients, the identified one or more subjects being made available for insertion into a SUBJECT field of the email based on the list of recipients entered by the user; and
inserting one of the one or more subjects into the SUBJECT field of the e-mail.

9. The computer readable storage medium of claim 8, wherein parsing the list of recipients to automatically identify one or more subjects associated with the list of recipients comprises accessing a data structure containing associations between a plurality of lists of recipients and corresponding subjects, the associations having been generated from previous emails composed by the user.

10. The computer readable storage medium of claim 8, wherein parsing the list of recipients to automatically identify one or more subjects associated with the list of recipients comprises:
determining that the e-mail SUBJECT field already contains an existing subject; and
identifying an alias for the existing subject based on the list of recipients.

11. The computer readable storage medium of claim 8, wherein inserting one of the one or more subjects into the SUBJECT field of the email comprises auto populating the SUBJECT field.

12. The computer readable storage medium of claim 8, wherein parsing the list of recipients to automatically identify one or more subjects associated with the list of recipients comprises accessing a data structure containing associations between a plurality of lists of recipients and corresponding subjects, the associations having been generated from previous e-mails composed by the user.

13. The computer readable storage medium of claim 8, wherein inserting one of the one or more subjects comprises:
prompting the user with a subject list of the identified one or more subjects; and
receiving a user selection of a subject from the subject list.

14. The computer readable storage medium of claim 13, wherein the subject list is arranged according to one of:
a chronological order based on when each of the one or more subjects was last used in another e-mail by the user; and
a frequency-based order according to the frequency with which the one or more subjects have been used in other emails by the user.

15. A system, comprising:
a memory cache; and
one or more computer processors configured to perform the steps comprising:
receiving a list of recipients input by a user for an e-mail;
parsing the list of recipients to automatically identify one or more subjects associated with the list of recipients, the identified one or more subjects being made available for insertion into a SUBJECT field of the email based on the list of recipients entered by the user; and
inserting one of the one or more subjects into the SUBJECT field of the e-mail.

16. The system of claim 15, wherein parsing the list of recipients to automatically identify one or more subjects associated with the list of recipients comprises accessing a data structure containing associations between a plurality of lists of recipients and corresponding subjects, the associations having been generated from previous emails composed by the user.

17. The system of claim 15, wherein parsing the list of recipients to automatically identify one or more subjects associated with the list of recipients comprises:
determining that the e-mail SUBJECT field already contains an existing subject; and
identifying an alias for the existing subject based on the list of recipients.

18. The system of claim 15, wherein inserting one of the one or more subjects into the SUBJECT field of the email comprises auto populating the SUBJECT field.

19. The system of claim 15, wherein parsing the list of recipients to automatically identify one or more subjects associated with the list of recipients comprises accessing a data structure containing associations between a plurality of lists of recipients and corresponding subjects, the associations having been generated from previous e-mails composed by the user.

20. The system of claim 15, wherein inserting one of the one or more subjects comprises:
prompting the user with a subject list of the identified one or more subjects; and
receiving a user selection of a subject from the subject list.

21. The system of claim 20, wherein the subject list is arranged according to one of:
a chronological order based on when each of the one or more subjects was last used in another e-mail by the user; and
a frequency-based order according to the frequency with which the one or more subjects have been used in other emails by the user.
